(19) United States
(12) Patent Application Publication
(10) Pub. No.: US 2007/0127783 A1
(43) Pub. Date: Jun. 7, 2007

(54) Image processing apparatus, method and program for controlling flesh color of image

(75) Inventors: Masayuki Kuramoto, Ashigarakami-gun (JP); Yasuharu Iwaki, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku (JP)

(21) Appl. No.: 11/634,172

(22) Filed: Dec. 6, 2006

(30) Foreign Application Priority Data
Dec. 6, 2005 (JP) 2005-352351

(51) Int. Cl. G06K 9/00

(52) U.S. Cl. 382/115

(57) ABSTRACT

Flesh color pixels that constitute flesh color areas of a captured image are determined with respect to the three attributes of color: lightness, chroma and hue, and lightness-chroma distribution of the flesh color pixels is determined in a coordinate plane whose vertical and horizontal axes represent lightness and chroma respectively, and lightness-hue distribution of the flesh color pixels is determined in a coordinate plane whose vertical and horizontal axes represent lightness and hue respectively. Image data of the captured image is subjected to a color conversion process, so as partly to change the lightness-chroma distribution or the lightness-hue distribution of the flesh color pixels, to control color of the flesh color areas. For example, it is possible to raise chroma values or change hue of the flesh color pixels only in a high lightness zone.

### FIELD OF THE INVENTION

The present invention relates to an image processing apparatus that controls a flesh color in captured image and a method and program for the flesh color control.

### BACKGROUND OF THE INVENTION

A good appearance of flesh color of the captured image greatly influences on an evaluation of the captured image. Therefore, when taking photographs of human subjects, professional photographers control the finish of the flesh color in the images so as to moderate shine or reflection on the skin, or enhance three-dimensional depth of the subject by carefully adjusting lighting or reflection boards to illuminate the subjects. Since such techniques for the flesh color control requires very sophisticated skills, it is desirable for amateur camera users that the advanced flesh color control is achieved by image processing.

Japanese Laid-open Patent Application No. 2004-64198 discloses an image processing apparatus that selects a certain color in captured image and controls the color. The image processing apparatus of -this prior art can control three attributes of color, or called three elements of color: lightness, chroma and hue of the certain color, individually as control items.

Graphs in FIG. 15 illustrate flesh color distribution curves, which approximately express flesh color distribution of all flesh color pixels of the captured image in a color coordinate system, wherein vertical axis represents lightness (L*) of of the flesh color, and horizontal axis represents chroma (C*) of the flesh color. In the color coordinate system with the vertical and horizontal axes of lightness and chroma, the flesh color pixels distribute along a curve, called lightness-chroma distribution curve, which has a convex shape with a peak in a higher chroma zone. In these graphs, solid lines represent the flesh color distribution curves in the beginning before the color control and broken lines represent the flesh color distribution curves after the color control. Respective flesh color distribution curves schematically illustrate the color control method by the above mentioned image processing apparatus.

As shown in the FIGS. 15A and 15B, when controlling the lightness by the prior art, the flesh color distribution curves shift up and down as the whole, to increases or decreases the lightness of almost all flesh color pixels. Also when controlling the chroma by the prior art, the chroma increases or decreases for most of the flesh color pixels, as shown in the FIGS. 15C and 15D. Therefore, in the case of raising the chroma of the flesh color, the whole flesh color distribution curve swells as if the peak of the curve was pulled to the right in the graph. On the other hand, in the case of lowering the chroma of the flash color, the whole flesh color distribution curve shrinks as if the peak of the curve was pushed to the left in the graph. In this way, the above mentioned image processing apparatus controls the lightness and chroma of the flesh color so that the flesh color area changes in whole.

Although the above mentioned image processing apparatus can control the flesh color by every attribute of color, the target of the color control always covers the whole flesh color area. Therefore, it is hard to control the flesh color partly and delicately. As for the chroma, for example, it is only possible to increase the whole chroma of the flesh color area, but it is impossible to increase the chroma only in high lightness zone of the flesh color. However, as known in the art, for the sake of moderating the shine or increasing the three-dimensional depth, the better result is obtained by increasing the chroma partly in the high lightness zone of the flesh color than in the whole flesh color area.

Moreover, according to the method of changing the whole flesh color distribution curve in the way as disclosed in the above mentioned prior art, it is difficult to soften or harden the gradation of flesh color. Hardening is effective to reproduce the flesh color vibrantly but makes wrinkles of the skin conspicuous. Softening makes the flesh color dull and faint but makes the wrinkles almost unnoticeable. The gradation is controlled by changing both the lightness and chroma. To be more precise, hardening is done by shifting the flesh color pixels along the above mentioned lightness-chroma distribution curve of the flesh color pixels toward the vicinity of its peak. On the other hand, shifting the flesh color pixels away from the peak of the curve softens the gradation.

### SUMMARY OF THE INVENTION

In view of the foregoing, a primary object of the present invention is to provide an image processing apparatus and a method and program for controlling color of flesh color areas of a captured image that contains a human subject, which make it possible to control the flesh colors delicately.

The present invention provides an image processing apparatus that comprises a device for reading out image data of the captured image from an image storage medium; and a flesh color control device for controlling color of the flesh color areas based on the image data, wherein the flesh color control device determines lightness, chroma and hue of individual flesh color pixels that constitute the flesh color areas, and subjects the image data to a color conversion process, so as partly to change distribution of the flesh color pixels at least in a coordinate plane whose vertical and horizontal axes represent two of the three attributes of color respectively.

The distribution of the flesh color pixels preferably includes lightness-chroma distribution in a coordinate plane whose vertical and horizontal axes represent lightness and chroma, or lightness-hue distribution in a coordinate plane whose vertical and horizontal axes represent lightness and hue.

The flesh color controller may change chroma values of those flesh color pixels among all flesh color pixels, which distribute either in a lower lightness zone or in a higher lightness zone of the lightness-chroma distribution plane.

The flesh color controller may change lightness values of those flesh color pixels among all flesh color pixels, which distribute either in a lower chroma zone or in a higher chroma zone of the lightness-chroma distribution plane.

The flesh color controller may change gradation of the flesh color areas by shifting lightness values and chroma values of the flesh color pixels in a given direction along an approximate curve to the lightness-chroma distribution.

The flesh color controller may change hue of those flesh color pixels which have random lightness values in the lightness-hue distribution.

Preferably, the image processing apparatus of the present invention is provided with a device for inputting a control amount for designating a degree of control on at least one of lightness, chroma, hue and gradation that varies depending upon lightness and chroma, wherein the flesh color controller controls color of the flesh color areas, taking account of the control amount.

More preferably, the image processing apparatus of the present invention comprises a storage device storing standard color conversion parameters that predetermine in which zone and in what direction the distribution of the flesh color pixels is to change, wherein the flesh color controller carries out the color conversion of the image data based on the standard color conversion parameters.

The standard color conversion parameters are preferably given as look-up tables or functions.

According to another preferred embodiment, the image processing apparatus is provided with a device for extracting the flesh color pixels from the image data, an analyzing device for analyzing the extracted flesh color pixels to obtain at least a flesh color distribution curve that is an approximate curve to the distribution of the extracted flesh color pixels, and a storage device storing at least a target distribution curve that shows predetermined target values for the color control of the flesh color pixels, wherein the flesh color controller compares the flesh color distribution curve with the target distribution curve, to carry out the color conversion of the flesh color pixels so as to make the flesh color distribution curve closer to the target distribution curve.

According to the present invention, the method of controlling color of flesh color areas of at least a human subject contained in a captured image based on image data of the captured image, comprises steps of:

reading out the image data from an image storage medium;

determining lightness, chroma and hue of flesh color pixels that constitute the flesh color areas; and

subjecting the image data to a color conversion process, so as partly to change distribution of the flesh color pixels at least in a coordinate plane whose vertical and horizontal axes represent two of the three attributes of color respectively.

The image processing apparatus of the present invention may be embodied by installing a program in a computer, the program causing the computer to execute steps of:

reading out the image data from an image storage medium;

defining lightness, chroma and hue of flesh color pixels that constitute the flesh color areas; and

subjecting the image data to a color conversion process, so as partly to change distribution of the flesh color pixels at least in a coordinate plane whose vertical and horizontal axes represent two of the three attributes of color respectively.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is a schematic diagram illustrating a print order reception apparatus embodying the present invention;

FIG. 2 is a block diagram illustrating a flesh color controller;

FIG. 3 is an explanatory diagram illustrating a 3D-LUT;

FIGS. 4A, 4B and 4C are explanatory diagrams illustrating how to change lightness, chroma and hue of the flesh color through 3D-LUTs respectively;

FIGS. 5A, 5B and 5C are explanatory diagrams illustrating how to change gradation of the flesh color;

FIG. 6 is an explanatory diagram illustrating an example of a control amount input box displayed on a screen;

FIG. 7 is a flow chart illustrating a flesh color control sequence;

FIG. 8 is an explanatory diagram illustrating examples of parameters for the flesh color control;

FIG. 9 is an explanatory diagram illustrating an embodiment where parameters are calculated using a function;

FIG. 10 is an explanatory diagram illustrating an example of a screen for editing flash color distribution curves;

FIG. 11 is an explanatory diagram illustrating how to calculate the parameters in the embodiment of FIG. 10;

FIGS. 12A and 12B are explanatory diagrams illustrating a flesh color control method where flesh color distribution curves are controlled to approximate to target distribution curves;

FIG. 13 is an explanatory diagram illustrating how to calculate the parameters in the embodiment of FIG. 12;

FIG. 14 is an explanatory diagram illustrating examples of different kinds of target flesh color distribution curves; and

FIGS. 15A, 15B, 15C and 15D are explanatory diagrams illustrating a conventional flesh color control method.

### DESCRIPTION OF THE PREFERRED EMBODIMENTS

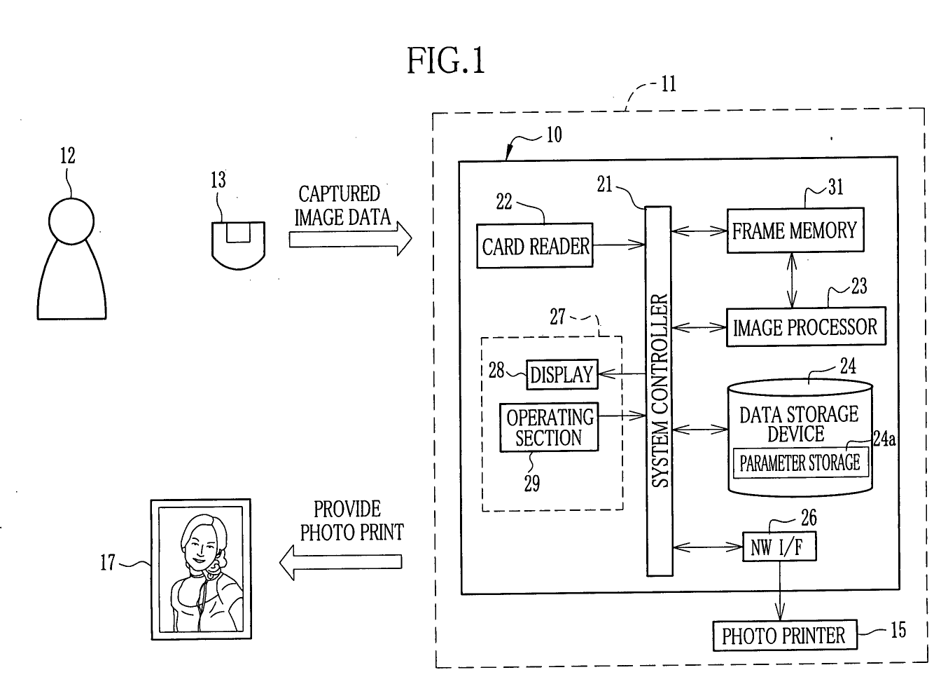

A print order reception apparatus 10 shown in FIG. 1 receives print orders of frame images captured and recorded as digital image data by a digital still camera. The print order reception apparatus 10 is installed for example in a photo printing service shop 11 and operated by an operator. The captured image data is stored in such a recording medium as a memory card 13, and brought to the photo printing service shop 11 by a customer 12. The captured image data is for example RGB data indicating densities of red, green and blue of every pixel.

The print order reception apparatus 10 is provided with functions of processing the captured image data as received, and the processed image data is transferred to a photo printer 15. The photo printer 15 outputs a high-definition photo print 17 by exposing photographic paper to laser beams that are generated based on the processed image data to form a latent image on the photographic paper, and thereafter processing the photographic paper for development.

The print order reception apparatus 10 consists of a system controller 21, a card reader 22, an image processor 23, a data storage device 24, a network interface 26, a console 27 and a frame memory 31. The console 27 has a display 28 and an operating section 29. The system controller 21 consists of CPU, ROM, and RAM and controls the overall operation of every part of the print order reception apparatus 10 based on directions from the operating section 29. The operating section 29 is an input device to input an operating command to the system controller 21, consisting of a mouse and a keyboard. The display 28 shows an operating screen or captured image. It is also possible to use a touch panel display which doubles as the operating section and display.

The card reader 22 accesses the memory card 13 to read the captured image data and takes it into the print order reception apparatus 10. The captured image data taken from the card reader 22 is written on the frame memory 31. The image processor 23 accesses the frame memory 31 to carry out various kinds of image processing to the captured image data.

The data storage device 24 is for example a hard disc drive that stores an operating system and various programs, and is provided with a parameter storage 24a which holds various parameters the image processor 23 uses for the image processing. After being processed by the image processor 23, the captured image data is written out on the data storage device 24 via the frame memory 31. The captured image data is then transferred to the photo printer 15 through the network interface 26. The network interface 26, is a communication interface for data communication with the photo printer 15.

The image processing by the image processor 23 includes flesh color control for human subjects contained in the captured image. The flesh color control delicately controls a flesh color by moderating shine on skin or enhancing three-dimensional depth of flesh color areas.

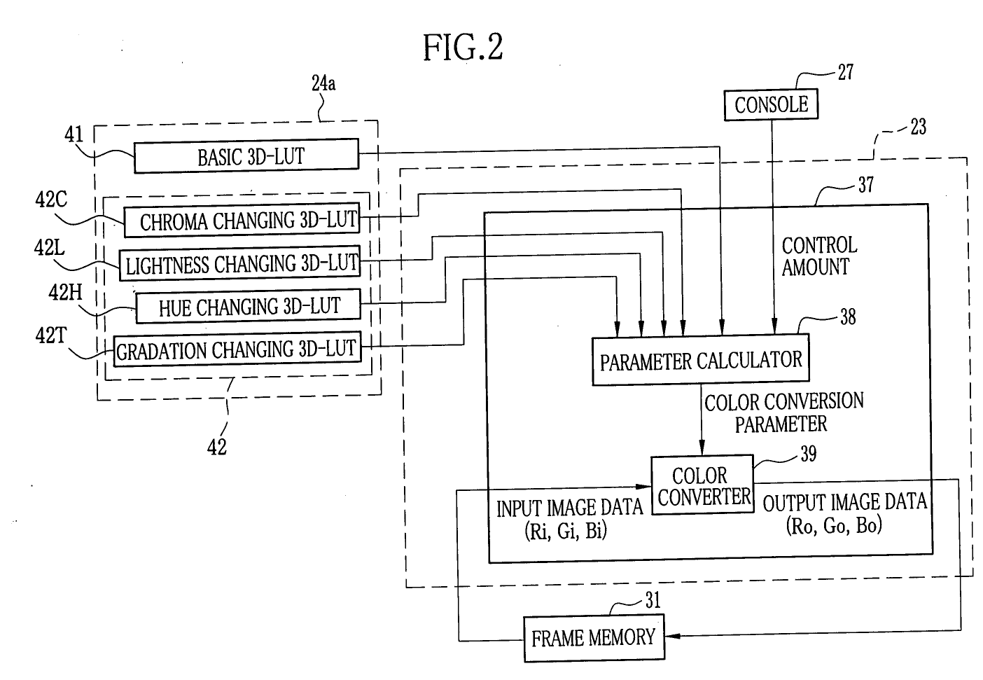

FIG. 2 is a block diagram illustrating the construction of the image processor 23. The image processor 23 is provided with a flesh color controller 37 to execute a color control process to a flesh color area in the captured image based on the captured image data read from the frame memory 31.

The flesh color controller 37 reads a color conversion parameter from the parameter storage 24a and controls the flesh color based on the color conversion parameter. The flesh color controller 37 is provided with a parameter calculator 38 and a color converter 39. The parameter calculator 38 calculates a color conversion parameter for the actual use by modifying the color conversion parameter read from the parameter storage 24a, based on a control amount input from the console 27. The color converter 39 converts color in the captured image data based on the color conversion parameter calculated in the parameter calculator 38.

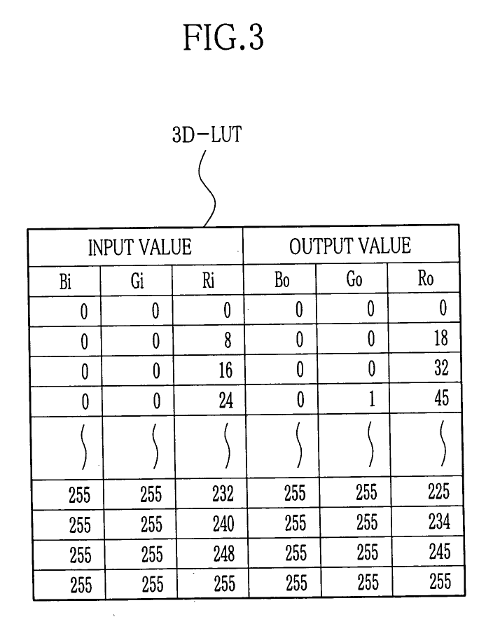

In the parameter storage 24a, the color conversion parameter is stored in a form of 3D-LUT (three-dimensional look-up table). As shown in FIG. 3, the 3D-LUT is table data on combination of tonal values of the three colors: red, blue and green, showing correspondence between input values (Ri, Gi and Bi) and output values (Ro, Go and Bo). For example, when the input values Ri, Gi and Bi of a certain pixel are respectively 0, 0 and 8, the corresponding output values Ro, Go and Bo are 0, 0 and 18 respectively. When each color is expressed in 8 bits (256 gradations), the 3D-LUT has 16,777,216 (the cube of 256) combinations of the input and output values. The color converter 39 coverts the color of each individual pixel of input image data, referring the 3D-LUT, and outputs color-converted output image data.

The parameter storage 24a stores for example a basic LUT 41 and standard LUTs for flesh color control 42 as the 3D-LUTs. The basic LUT 41 defines parameters for color conversion except the flesh color control, and is used as basic parameters for the flesh color control. The standard LUTs for flesh color control 42 predetermine parameters for the standard flesh color control and consists of for example a chroma changing 3D-LUT 42C, a lightness changing 3D-LUT 42L, a hue changing 3D-LUT 42H and a gradation changing 3D-LUT 42T.

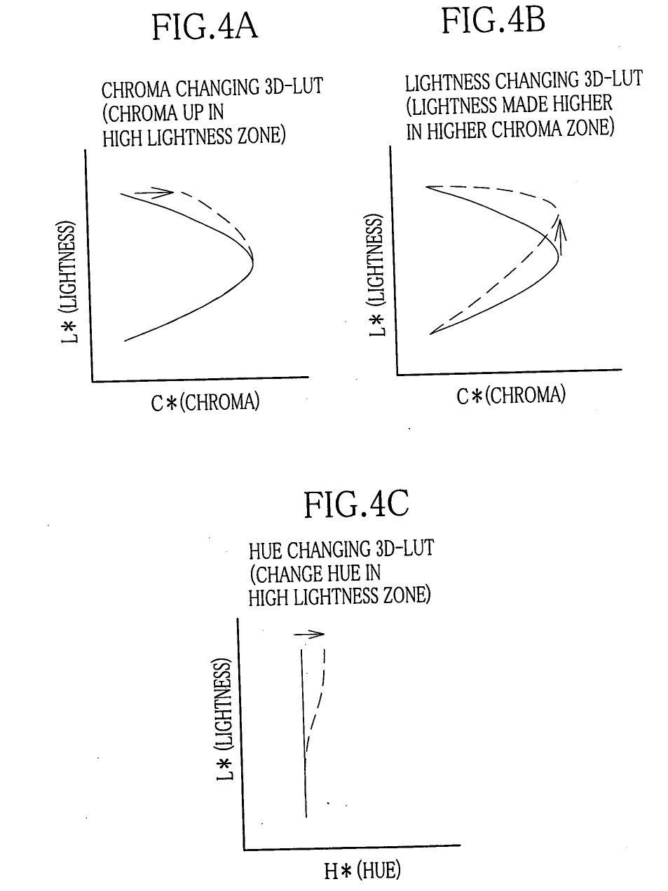

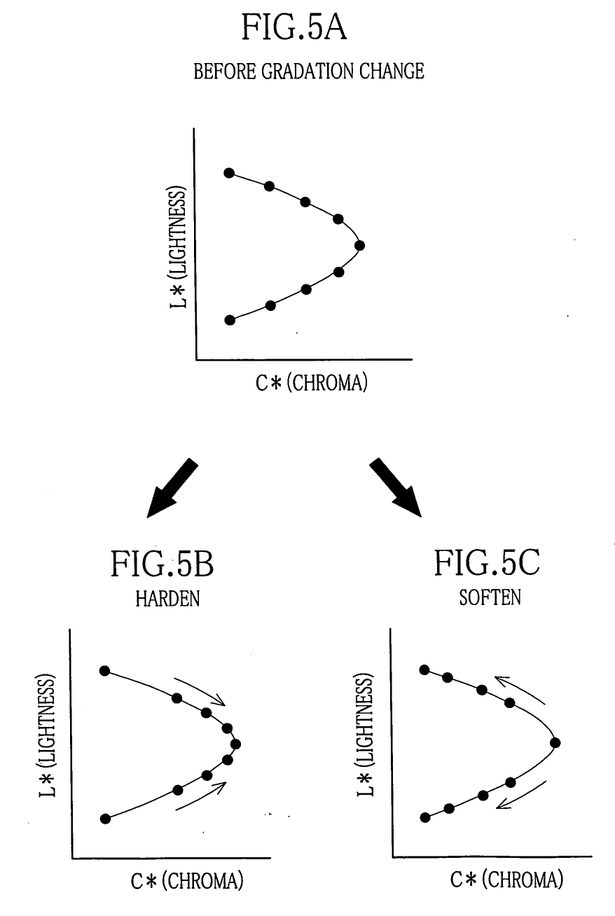

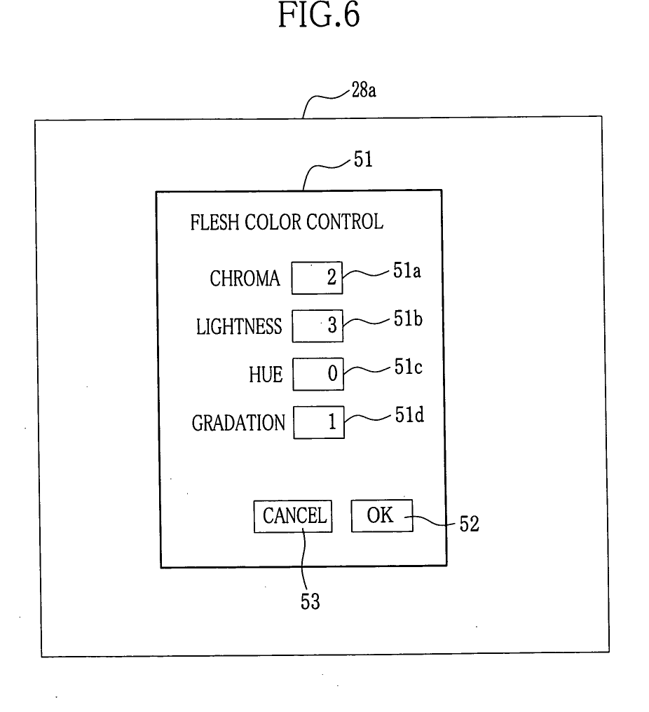

As shown in FIGS. 4 and 5, the standard LUTs for flesh color control 42 are designed so that flesh color distribution in the flesh color area of the captured image partly changes after the color conversion. When plural flesh color pixels which constitute the flesh color area are expressed in the color notation system using the three attributes of lightness (L*), chroma (*C) and hue (H*), it is possible to determine how the flesh color pixels distribute in a colorimetric plane of color coordinate system wherein a vertical axis represents one of the above-mentioned three attributes of color and a horizontal axis represents another attribute. The distribution of the flesh color pixels in the colorimetric plane will be called the flesh color distribution. Graphs in the FIGS. 4 and 5 indicate flesh color distribution curves that approximate to the flesh color distributions. As set forth in detail later, the flesh color distribution curves are changed partly so as to heighten the chroma or lightness or to change the hue of only a part of all flesh color pixels. For example, it is possible to change the chroma and hue of only those flesh color pixels which are in a higher chroma zone or, on the contrary, in a lower chroma zone.

Solid lines in respective graphs of FIGS. 4A, 4B and 4C represent the flesh color distribution curves before the color conversion by the standard LUTs for flesh color control 42, and broken lines represent the flesh color distribution curves after the color conversion. The flesh color distribution curves in FIGS. 4A and 4B express lightness-chroma distribution of the flesh color pixels in graphs with the vertical axis of lightness and horizontal axis of chroma.

As shown in FIG. 4A, the chroma changing 3D-LUT 42C is predetermined so that the chroma of the flesh color pixel goes up only in the high lightness zone by the color conversion. As shown in FIG. 4B, the lightness changing 3D-LUT 42L is predetermined so that the lightness in the high chroma zone goes up by the color conversion. The flesh color distribution curves in the graph of FIG. 4C express lightness-hue distribution of the flesh color pixels, wherein the vertical axis represents lightness and the horizontal axis represents hue. The hue changing 3D-LUT 42H is predetermined so that the hue of the flesh color pixels changes only in the high lightness zone by the color conversion.

FIG. 5 is an explanatory diagram illustrating a gradation (tone) change process. Respective graphs in FIGS. 5A, 5B and 5C represent the flesh color distribution curves which indicate lightness-chroma distribution of the flesh color pixels. Dots on the flesh color distribution curves show how the flesh color pixels distribute, and the gradation (tone) changes by shifting the lightness and chroma of the flesh color pixels along the flesh color distribution curve in a given direction. FIG. 5A illustrates the distribution before the color conversion that is gradation change, and the flesh color pixels distribute uniformly along the flesh color distribution curve.

As shown in FIG. 5B, changing the lightness and chroma of the respective flesh color pixels so that the distribution of the flesh color pixels shifts along the curve from a high lightness and low chroma zone and a low lightness and low chroma zone to a middle lightness and high chroma zone hardens the gradation (tone) of the flesh color. On the other hand, as shown in FIG. 5C, changing the lightness and chroma of the respective flesh color pixels so that the distribution of the flesh color pixels shifts along the curve from a high chroma and middle lightness zone to a high lightness and low chroma zone and a low lightness and low chroma zone softens the gradation (tone) of the flesh color. For example, the gradation changing 3D-LUT 42T is predetermined so as to soften the gradation of the flesh color area of the image by changing partly the flesh color distribution.

As described above, the standard LUTs for flesh color control 42 predetermine which zone of the flesh color distribution will be changed and which direction the zone will change, on executing the standard flesh color control. Moreover, the standard LUTs for flesh color control 42 modify the degree of control according to input control amount.

FIG. 6 indicates a GUI (graphical user interface) for inputting the control amount. When the flesh color control is selected from an image process menu, a control amount input box 51 is displayed on a display screen 28a of the display 28. The control amount input box 51 is provided with input boxes 51a, 51b, 51c and 51d corresponding to four control items: chroma, lightness, hue and gradation respectively. Numerical values are input to the input boxes 51a, 51b, 51c and 51d as the control amounts for chroma, lightness, hue and gradation respectively.

An OK button 52 fixes the input control amount and gives a command to execute the flesh color control. A cancel button 53 cancels the flesh color control. Clicking the cancel button 53 causes the control amount input box 51 to disappear from the display screen 28a, which then returns to the previous condition.

The parameter calculator 38 modifies the standard LUTs for flesh color control 42 according to the input control amounts and produces a composite LUT by compounding the standard LUTs for flesh color control 42 and the basic LUT 41.

The following formula (1) is for calculating the composite LUT:
Composite LUT=LUT_org+α(LUT_C−LUT_org)+β(LUT_L−LUT_org)+γ(LUT₋H−LUT_org)+ρ(LUT_T−LUT_org) (1)
wherein LUT_org, LUT_C, LUT_L, LUT_H and LUT_T represent the basic LUT 41, the chroma changing LUT 42C, the lightness changing LUT 42L, the Hue changing LUT 42H and the gradation changing LUT 42T respectively, and α, β, γ and ρ represent weighting coefficients whose values range from 0 to 1 and are calculated according to the input control values.

Although the above formula (1) calculates differential values for the respective flesh color control items between the basic LUT 41 and the standard LUTs 42, it is alternatively possible to prepare differential LUTs showing the differential values instead of the standard LUTs 42. In that case, the composite LUT is expressed by the following formula (2):
Composite LUT=LUT_org+αΔLUT_C+βΔLUT_L+γΔLUT_H+ρΔLUT_T (2)
wherein ΔLUT_C, ΔLUT_L, ΔLUT_H and ΔLUT_T represent the differential values for the respective flesh color control items.

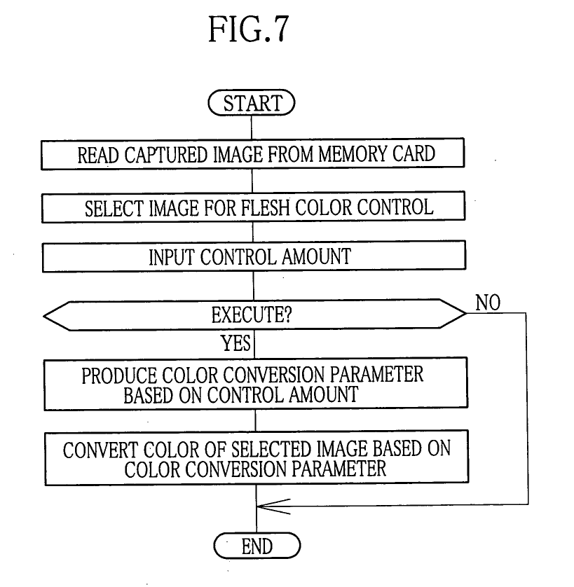

Now the operation of the above described embodiment will be explained while referring to a flowchart in FIG. 7. An operator sets the memory card 13 in the print order reception apparatus 10. After the console 27 displays thumbnails of the captured images as stored in the memory card 13, a user selects an appropriate one of the captured images. When a main subject of the captured image is a person, the flesh color control is selected from the image process menu to display the control amount input box 51 on the display screen 28a and then input a control amount for each of the control items: chroma, lightness, hue and gradation.

After the input control amount is fixed and the OK button 52 is clicked, the image data of the selected image is read out from the memory card 13, to execute the image processing. The parameter calculator 38 calculates weighting factors α, β, γ and β based on the input control amount and reads the basic LUT 41 and the standard LUTs for flesh color control 42 from the parameter storage 24a and produces the composite LUT in accordance with the above-mentioned formula (1).

The produced composite LUT is output as color conversion parameter to the color converter 39. The color converter 39 converts the color of the input image data based on the color conversion parameter and outputs the color-converted image data. Because the flesh color control is executed so as to change the flesh color distribution partly, to moderate the shine of the skin or enhance the three-dimensional depth, the finish of the flesh color portion gets finer than conventional.

In the above described embodiment, as the color conversion parameter for the standard flesh color control, one LUT is prepared for each individual control item. It is also possible to prepare plural kinds of LUTs for flesh color control.

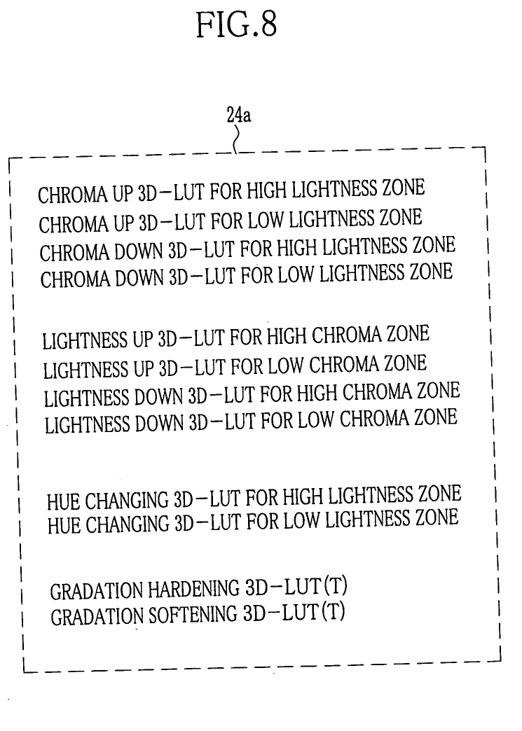

For example such plural kinds of LUTs as shown in FIG. 8 are stored in the parameter storage 24a. In this example, four kinds of 3D-LUTs are prepared for the chroma changing: a chroma up 3D-LUT for high lightness zone, a chroma up 3D-LUT for low lightness zone, a chroma down 3D-LUT for high lightness zone and a chroma down 3D-LUT for low lightness zone. For the lightness changing 3D-LUT, four kinds are prepared: a lightness up 3D-LUT for high chroma zone, a lightness up 3D-LUT for low chroma zone, a lightness down 3D-LUT for high chroma zone and a lightness down 3D-LUT for low chroma zone.

For the hue changing 3D-LUT, two kinds are prepared: a hue changing 3D-LUT for high lightness zone and a hue changing 3D-LUT for low lightness zone. For the gradation changing 3D-LUT are prepared two kinds: a gradation hardening 3D-LUT and a gradation softening 3D-LUT.

These LUTs are selected through the console 27. The operator selects the LUT at their requests and inputs the control amount. The parameter calculator 38 produces the color conversion parameter based on the selected LUT and control amount.

Besides the above-mentioned examples, there are various kinds and combinations of LUTs. For example, in the above described embodiment, the whole zone of the flesh color distribution is divided into two zones: higher lightness or chroma zone and lower lightness or chroma zone, and the LUTs are prepared for the respective zones. It is, however, possible to divide the whole flesh color area into three zones like high, middle and low lightness or chroma zones and to provide LUTs for controlling colors of the respective zones partly. Of course, it is also possible to divide the whole flesh color area into more than three zones.

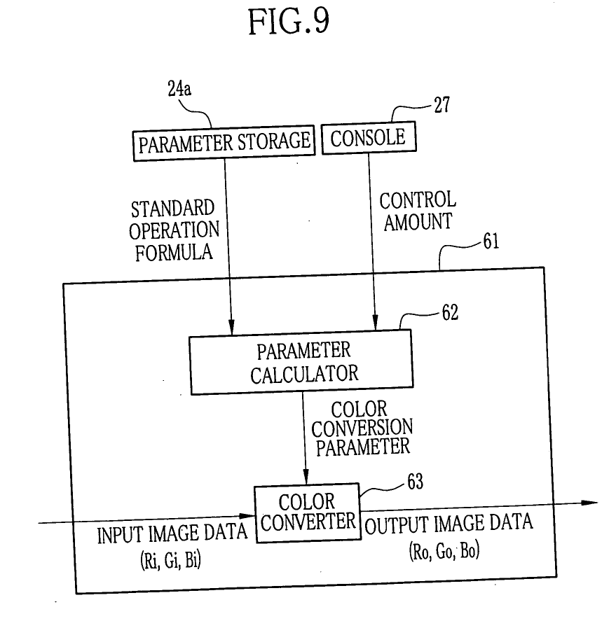

In the above described embodiment, the 3D-LUTs are used as the color conversion parameters. However, the color conversion parameters may be functions (operation formulas) instead of the 3D-LUTs. In this case, as shown in FIG. 9, a standard operation formula for standard color conversion is preset in a parameter storage 24a. A flesh color controller 61 reads the standard operation formula from the parameter storage 24a. A parameter calculator 62 modifies the standard operation formula based on control amounts input from a console 27 and produces a color conversion parameter. A color converter 63 converts color of input image data based on the color conversion parameter and outputs color-converted image data.

In the above described embodiment, the color conversion parameter for the standard color conversion is prepared in advance, based on which the flesh color control is executed. It is also possible to permit a user to edit a flesh color distribution curve as their request and to produce based on the result of edition a color conversion parameter for flesh color control.

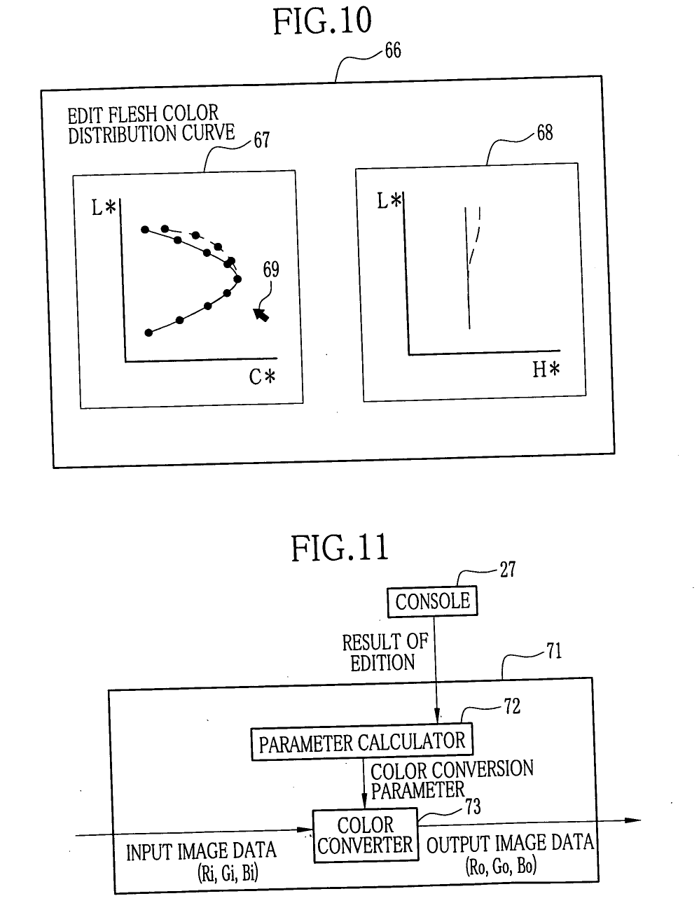

FIG. 10 illustrates an edit screen 66 of the flesh color distribution curve displayed on the display 27. The edit screen 66 is provided with a window for editing a lightness-chroma distribution curve 67 and a window for editing a lightness-hue distribution curve 68. With a pointer 69 of the mouse, the operator is able to edit the flesh color distribution curve to a given form by dragging black points on the flesh color distribution curves, i.e. the curves displayed on the windows 67 and 68. For example, the lightness-chroma distribution curve shown in a solid line is edited into one shown in a broken line.

Because both the lightness-chroma distribution curve and lightness-hue distribution curve are expressed in the graphs with the vertical axis of the lightness, the result of edition in the window 67 reflects in the other window 68. Thus, the control amount can be input by editing the flesh color distribution curve itself at user's request, increasing the flexibility of the color control. In addition, displaying the shape of the edited flesh color distribution curve makes it easier to instinctively understand the result of edition. As shown in FIG. 11, the result of edition is input from the console 27 to a flesh color Controller 71. A parameter calculator 72 calculates the color conversion parameter based on the result of edition, and a color converter 73 converts color.

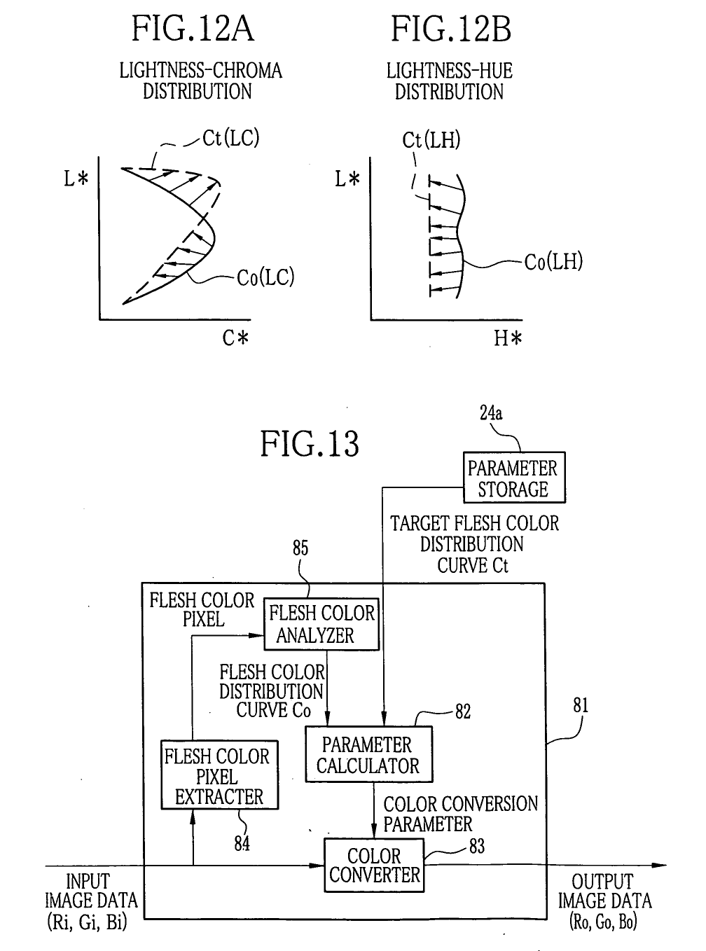

In the above described embodiment, the color control is executed by assigning which zone of the flesh color distribution is to be modified, and in what direction and how much degree the modification should be done, with reference to the flesh color distribution of a selected image. As shown in FIG. 12, however, it is also possible to store a target flesh color distribution curve Ct in advance, which corresponds to an ideal flesh color distribution. An actual flesh color distribution curve Co is detected by analyzing the flesh color distribution of the selected image, and the flesh color control is so executed that the actual flesh color distribution curve Co gets close to the target flesh color distribution curve Ct, wherein it is possible to make the curve Co coincide with the curve Ct, as well as to make it closer to the curve Ct.

In FIG. 12A, a solid line is the flesh color distribution curve Co (LC) showing the actual lightness-chroma distribution of the selected image and a broken line illustrates the target flesh color distribution curve Ct (LC) for the lightness-chroma distribution. In FIG. 12B, a solid line illustrates the flesh color distribution curve Co (LH) showing the actual lightness-hue distribution of the selected image and a broken line illustrates the target flesh color distribution curve Ct (LH) for the lightness-he distribution.

In order to execute the flesh color control with reference to the target flesh color distribution curve Ct, the target flesh color distribution curve Ct is stored in the parameter storage 24a. For example as shown in FIG. 13, a flesh color controller 81 is provided with a parameter calculator 82, a color converter 83, a flesh color pixel extractor 84 to extract the flesh color pixels of the flesh color area from the input image data and a flesh color analyzer 85 that detects the flesh color distribution curve Co by analyzing the actual flesh color distribution based on the extracted flesh color pixels.

The flesh color pixel extractor 84 extracts the flesh color pixels of the selected image based on for example predetermined information on flesh color. The flesh color information defines a range of those colors which should be extracted as the flesh color pixels. The flesh color pixel extractor 84 extracts those pixels which exist in the color range defined by the flesh color information, comparing color of each individual pixel of the captured image data with the flesh color information. As another way of extracting the flesh color pixels, it is also possible to extract the flesh color pixel from a facial image detected from the captured image by pattern matching.

The parameter calculator 82 compares the flesh color distribution curve Co input from the flesh color analyzer 85 with the target flesh color distribution curve Ct read from the parameter storage 24a, and calculates the color conversion parameter to make the flesh color distribution curve Co closer to the target flesh color distribution curve Ct. The color converter 83 converts the color of the input image data based on the color conversion parameter and outputs the color-converted image data. These procedures are convenient because it is possible to analyze the selected image one by one and to automatically control the color according to the target values. It is of course possible to input the control amount manually for fine control in order to reflect user's request.

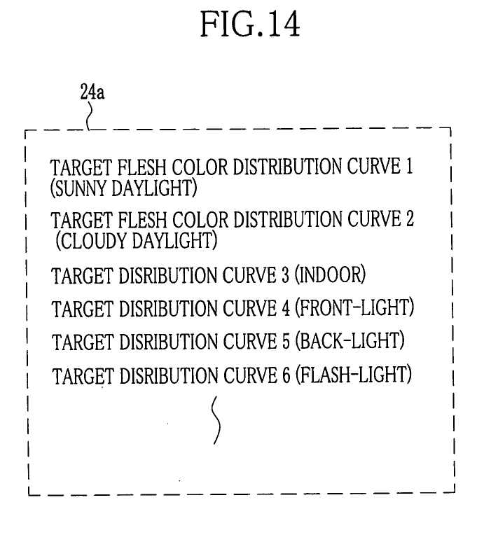

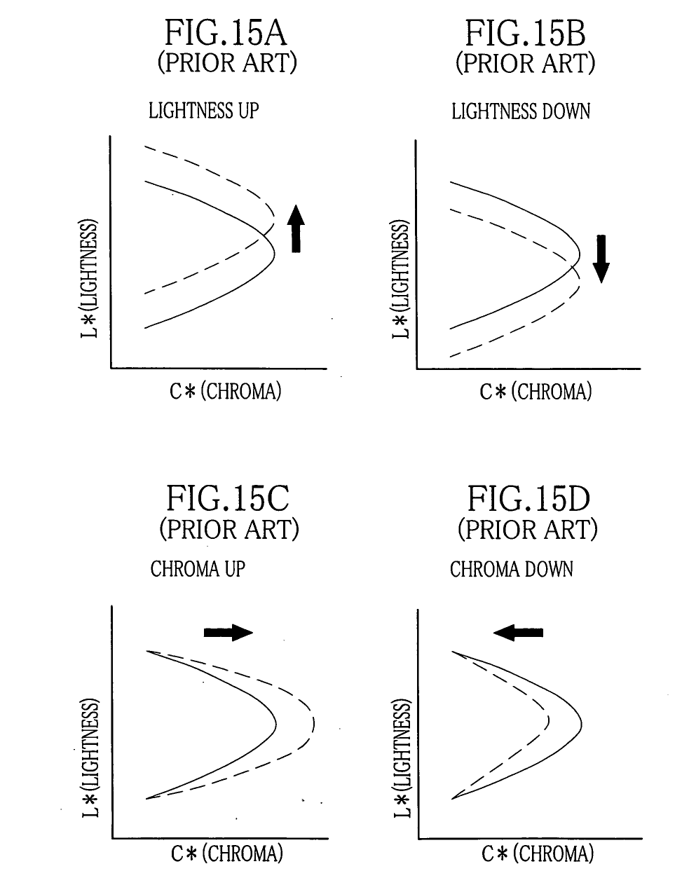

The target flesh color distribution curve is not limited to one. It is also possible to prepare plural target flesh color distribution curves for choice. FIG. 14 illustrates an example of optional target flesh color distribution curves prepared for different kinds of light sources, because the kind of the light source has a strong influence on the finish of flesh color as a photo environment condition. In the example, there are two kinds of target flesh color distribution curves for daylight: a target flesh color distribution curve 1 for sunny daylight and a target flesh color distribution curve 2 for cloudy daylight. In addition, there are a target distribution curve 3 for indoor lighting, a target distribution curve 4 for front-light, a target distribution curve 5 for back-light and a target distribution curve 6 for flash-light. Besides this example, it is also possible to prepare other kinds of target distribution curves. For example, it is possible to prepare target distribution curves according to racial difference in flesh color, or according to distinction based on sex or age, considering that people tend to have different taste in the finish of photographs because of their sex and age.

In the above described embodiment, all of the four items, i.e. lightness, chroma, hue and gradation, are changeable for the flesh color control. However, the present invention is applicable to a case where at least one item is changeable for flesh color control, instead of all items.

In the above described embodiment, the print order reception apparatus is provided with the function of the flesh color control. It is, however, possible to apply the present invention to an image processing apparatus or printer that has no function of print order reception. Of course the present invention also includes a case where the function of the flesh color control is embodied in the form of a program for a computer. Moreover it is possible to apply the present invention to a print order reception server which receives print orders via such a communication network as the Internet.

Although the present invention has been described with respect to the preferred embodiments, the present invention is not to be limited to these embodiments but, on the contrary, various modifications will be possible without departing from the scope of claims appended hereto.

What is claimed is:

1. An image processing apparatus for controlling color of flesh color areas of a captured image that contains a human subject, said image processing apparatus comprising:
a device for reading out image data of said captured image from an image storage medium; and
a flesh color control device for controlling color of the flesh color areas based on the image data, wherein said flesh color control device determines lightness, chroma and hue of individual flesh color pixels that constitute the flesh color areas, and subjects the image data to a color conversion process, so as partly to change distribution of the flesh color pixels at least in a coordinate plane whose vertical and horizontal axes represent two of the three attributes of color respectively.

2. An image processing apparatus as claimed in claim 1, wherein said flesh color control device changes the distribution of the flesh color pixels by partly changing values of one of the three attributes of color of those flesh color pixels having random values with respect to another attribute of color.

3. An image processing apparatus as claimed in claim 1, wherein the distribution of the flesh color pixels includes at least one of lightness-chroma distribution in a coordinate plane whose vertical and horizontal axes represent lightness and chroma, and lightness-hue distribution in a coordinate plane whose vertical and horizontal axes represent lightness and hue.

4. An image processing apparatus as claimed in claim 3, wherein said flesh color controller changes chroma values of those flesh color pixels among all flesh color pixels, which distribute either in, a lower lightness zone or in a higher lightness zone of the lightness-chroma distribution plane.

5. An image processing apparatus as claimed in claim 3, wherein said flesh color controller changes lightness values of those flesh color pixels among all flesh color pixels, which distribute either in a lower chroma zone or in a higher chroma zone of the lightness-chroma distribution plane.

6. An image processing apparatus as claimed in claim 3, wherein said flesh color controller changes gradation of the flesh color areas by shifting lightness values and chroma values of the flesh color pixels in a given direction along an approximate curve to the lightness-chroma distribution.

7. An image processing apparatus as claimed in claim 3, wherein said flesh color controller changes hue of those flesh color pixels which have random lightness values in the lightness-hue distribution.

8. An image processing apparatus as claimed in claim 1, further comprising a device for inputting a control amount for designating a degree of control on at least one of lightness, chroma, hue and gradation that varies depending upon lightness and chroma, wherein said flesh color controller controls color of the flesh color areas, taking account of the control amount.

9. An image processing apparatus as claimed in claim 1, further comprising a storage device storing standard color conversion parameters that predetermine in which zone and in what direction the distribution of the flesh color pixels is to change, wherein said flesh color controller carries out the color conversion of the image data based on said standard color conversion parameters.

10. An image processing apparatus as claimed in claim 9, further comprising a device for inputting a control amount to designate the degree of control on at least one of lightness, chroma, hue and gradation of the image, and a parameter calculator for correcting said standard color conversion parameters based on the control amount.

11. An image processing apparatus as claimed in claim 9, wherein said standard color conversion parameters are given as look-up tables or functions.

12. An image processing apparatus as claimed in claim 1, further comprising a device for extracting the flesh color pixels from the image data, an analyzing device for analyzing the extracted flesh color pixels to obtain at least a flesh color distribution curve that is an approximate curve to the distribution of the extracted flesh color pixels, and a storage device storing at least a target distribution curve that shows predetermined target values for the color control of the flesh color pixels, wherein said flesh color controller compares the flesh color distribution curve with the target distribution curve, to carry out the color conversion of the flesh color pixels so as to make the flesh color distribution curve closer to the target distribution curve.

13. An image processing apparatus as claimed in claim 12, wherein said storage device stores plural kinds of said target distribution curves, among which said flesh color controller selects appropriate ones.

14. An image processing apparatus as claimed in claim 13, wherein said plural kinds of target distribution curves are prepared for different environmental conditions of shooting.

15. An image processing apparatus as claimed in claim 13, wherein said plural kinds of target distribution curves are prepared according to racial difference in flesh color, or considering user's taste in the finish of photographs that differs according to their sex and age.

16. A method of controlling color of flesh color areas of at least a human subject contained in a captured image based on image data of said captured image, said method comprising steps of:
reading out the image data from an image storage medium;
determining lightness, chroma and hue of flesh color pixels that constitute the flesh color areas; and
subjecting the image data to a color conversion process, so as partly to change distribution of the flesh color pixels at least in a coordinate plane whose vertical and horizontal axes represent two of the three attributes of color respectively.

17. A program for a computer to execute an operation for controlling color of flesh color areas of at least a human subject contained in a captured image based on image data of said captured image, said program causing the computer to execute steps of:
reading out the image data from an image storage medium;
defining lightness, chroma and hue of flesh color pixels that constitute the flesh color areas; and
subjecting the image data to a color conversion process, so as partly to change distribution of the flesh color pixels at least in a coordinate plane whose vertical and horizontal axes represent two of the three attributes of color respectively.
